(19) United States
(12) Patent Application Publication
(10) Pub. No.: US 2012/0067324 A1
(43) Pub. Date: Mar. 22, 2012

(54) Toroidal internal combustion rotary engine

(76) Inventor: Denny Cleveland Williams, Sanford, FL (US)

(21) Appl. No.: 12/807,220

(22) Filed: Aug. 31, 2010

(51) Int. Cl. F04C 15/06; F02B 53/04

(52) U.S. Cl. 123/243; 418/147

(57) ABSTRACT

A rotary internal combustion engine having a single toroidal cylinder and a set of orbital pistons attached to a rotating head or toroidal cylinder cover. The toroidal cylinder is divided into two chambers by two rotating disk valves perpendicular to the toroidal cylinder. Each rotating disk valve has a piston slot or opening that allows the orbital pistons to pass through the rotating disk valves while maintaining sealed chambers within the toroidal cylinder. The rotating disk valve that seals the compression chamber has a void within it that forms a pre-combustion chamber, which receives the compressed fuel-air mixture and releases it on the opposite side of the disk valve into the combustion chamber. The two orbital pistons and rotating disk valves allow the four cycles of the toroidal internal combustion engine to occur simultaneously within the toroidal cylinder.

### STATEMENT REGARDING FEDERALLY SPONSORED RESEARCH OR DEVELOPMENT

No part of this invention has been prepared under federally sponsored research and development.

### REFERENCE TO COMPUTER PROGRAM LISTING COMPACT DISC APPENDIX

Not Applicable.

### CROSS-REFERENCE TO RELATED APPLICATIONS

Not Applicable.

### BACKGROUND OF THE INVENTION

1. Field of Invention

This invention relates to internal combustion engines and, more specifically, to a toroidal rotary internal combustion engine with all the internal moving components continuously rotating as the engine completes its four cycles: intake, compression, combustion and exhaust.

2. Description of Related Art

Prior art of the internal combustion rotary engine includes more than 600 related patents. The Wankel, U.S. Pat. No. 2,988,008, the only rotary engine to reach the global market, has problems with vibrations caused by an internal piston that moves in an eccentric path as the engine goes through its cycles of intake, compression, combustion and exhaust. The Quasiturbine, U.S. Pat. No. 6,899,075, has attempted to solve the vibration problem by using an internal piston with a grater number of sides than the Wankle. However, the Quasiturbine has not yielded the performance required by the market. An engine that presents a more true rotary motion is McCall, U.S. Pat. No. 3,751,192. This engine has a pair of intermeshed rotors set perpendicular to one another. As these rotors turn, chambers are formed between the rotors that are then reduced or expanded to complete the cycles of the engine. However, the gear drive train is complicated to manufacturer and maintain. Riley, U.S. Pat. No. 6,129,067, also takes advantage of a true rotary motion with three (3) intermeshed rotors. This design presents a sealing problem that limits the engine's ability to produce high compression ratios and torque. A number of patents such as Elsherbini, U.S. Pat. No. 6,536,403, have proposed a rotor with vanes or sliding walls that move in and out of the rotor while making contact with the exterior wall of an eccentric chamber. These vanes form smaller chambers for compression and combustion between the vanes as they rotate within the eccentric chamber. These engines have reciprocating vanes that extend and retract during operation and produce a difference in radial acceleration that, in turn, creates vibration within the engines. Vibration in the engines from reciprocating parts or eccentric rotating parts shortens the life expectancy of the engines and hinders the use of alternative materials such as ceramics for engine components.

### BRIEF SUMMARY OF THE INVENTION

The primary objective of this invention is to overcome some of the shortcomings of the reciprocating internal combustion engines that are in use today.

The object of the present invention is to provide a smaller and smoother operating engine that is equivalent in horsepower to the reciprocating internal combustion engine. The footprint and mass of the present invention is much smaller than the reciprocating internal combustion engine. With two (2) combustion cycles taking place every revolution makes the present invention equivalent to a four (4) cylinder reciprocating internal combustion engine. The reduced vibration by elimination of the reciprocating components and the smaller overall package allows the present invention to operate at greater speeds and produces more horsepower than its counterpart of equal mass.

Another objective of the present invention is to provide a rotary internal combustion engine that can be made from materials other than the conventional metals used today. All the moving components in the present invention continuously rotate in a circular motion, which reduces vibration by eliminating the reciprocating motion of internal components as in the reciprocating internal combustion engine. Because of the reduced vibration, other materials, including ceramics, can be used to produce the engine components, which would allow for higher operating temperatures and more efficient combustion. Alternative materials will make the present invention more economical to produce as well as a greater horsepower-to-weight ratio.

Another objective of the present invention is to provide a rotary internal combustion engine with greater torque that will be readily accepted as an alternative to the reciprocating internal combustion engine. The power stroke in the present invention uses 140 degrees of rotation within the toroidal cavity for the combustion cycle. This longer power stroke allows for better use of the fuel's potential energy and also reduces exhaust temperatures by allowing greater expansion of the combusted gases. The torque produced by the present invention will surpass that of the reciprocating internal combustion engine because of the greater than 12-inch power stroke and the elimination of the reciprocating internal components.

The present invention consists of a stationary engine casing and three primary moving components—the rotary head and two (2) disk valves. The orbital pistons and compression rings are fixed to the rotary head forming a single rotating unit. The rotary head seals the toroidal cylinder cavity containing the compression chamber and combustion chamber. The rotary disk valves seal the ends of the compression chamber and the combustion chamber and allow movement of the pistons within the chambers to perform the intake, compression, combustion and exhaust cycles. Also, the rotary disk valves have piston slots, which allow the pistons to pass through the rotary disk valves into the next chamber while maintaining the pressures within the chambers.

### BRIEF DESCRIPTION OF DRAWINGS

FIG. 1 is a front perspective view of the assembled rotary engine.

FIG. 2 is a top perspective view of the assembled rotary engine.

FIG. 3 is an exploded view of the rotary engine.

FIG. 4 is a list of the rotary engine components.

FIG. 5 is a top perspective view of the rotary engine with the rotary head removed.

FIG. 6 is a front perspective view of the rotary engine with the front engine casing removed.

FIG. 7 is a plan view showing the intake, compression, combustion and exhaust cycles of the rotary engine.

FIG. 8 is a section view cut along line A-A in FIG. 7 showing the rotary piston passing through the compression valve piston slot.

FIG. 9 is a section view cut along line B-B in FIG. 7 showing the valve drive gears.

FIG. 10 is a section view cut along line C-C in FIG. 7 showing the rotary engine drive train.

FIG. 11 is a detail of the intake disk valve showing the orbital piston slot.

FIG. 12 is a front detail of the compression disk valve showing the orbital piston slot and the pre-combustion chamber (shown in dashed lines).

### DETAILED DESCRIPTION OF THE INVENTION

The present invention is an internal combustion rotary engine. Each of its main components are described as follows:

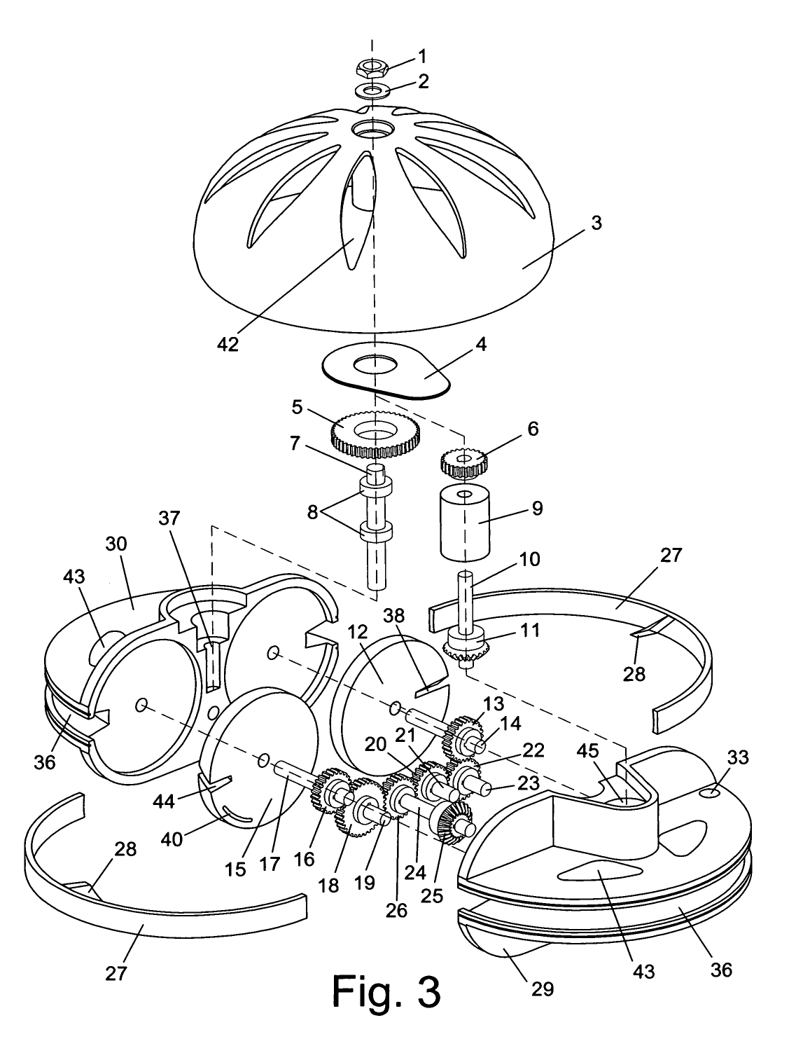

The rotary head 3, which also acts as the engine cover and seals the cylinder cavity 36, is fixed to the compression rings 27 and the orbital pistons 28 to form a singular unit that rotates on the spindle bearings 8 that rest on the spindle 7 fixed at the center of the engine in the spindle cavity 37. An output gear 5 is fixed to the rotary head 3 FIG. 3, which, in turn, forces rotation of the vertical driveshaft gear 6, which is fixed to the vertical drive shaft 10.

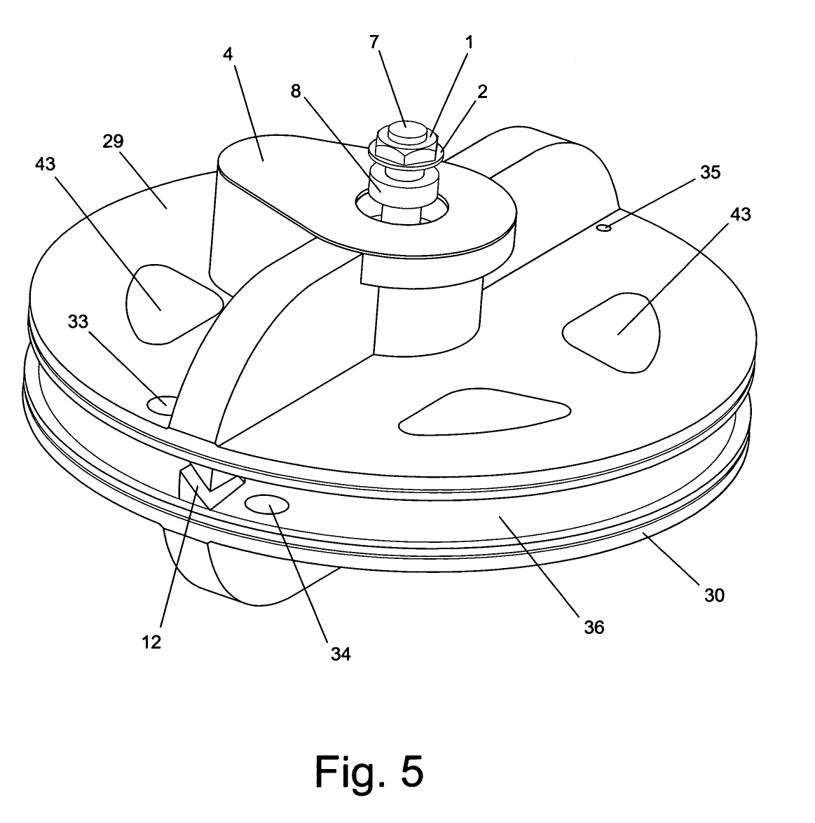

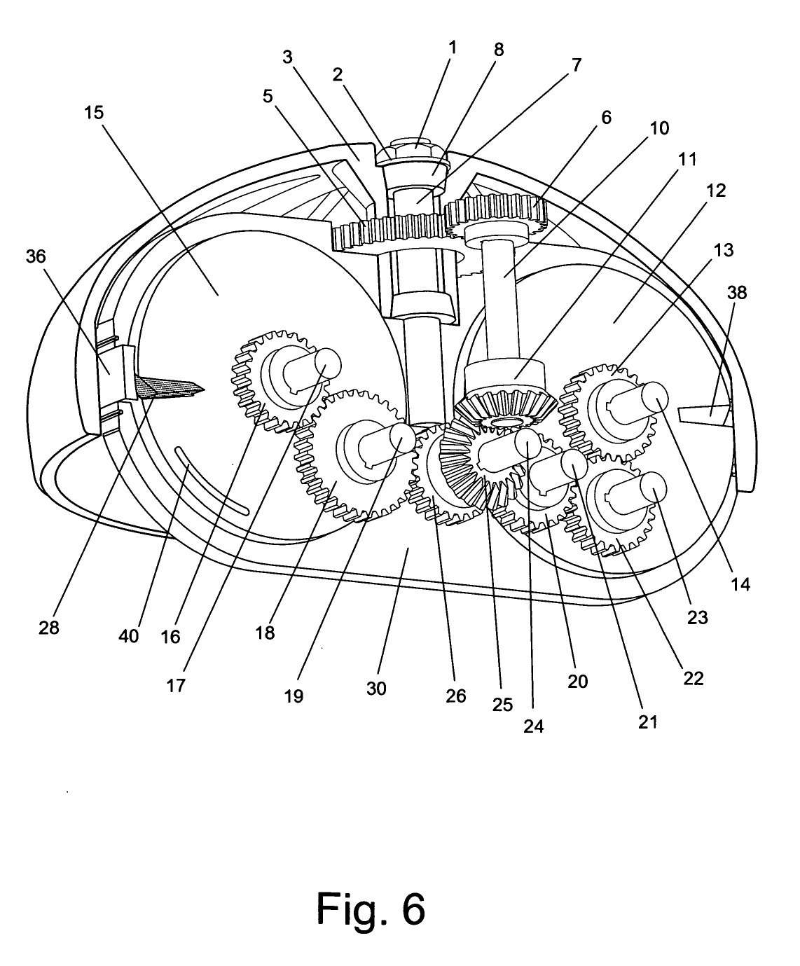

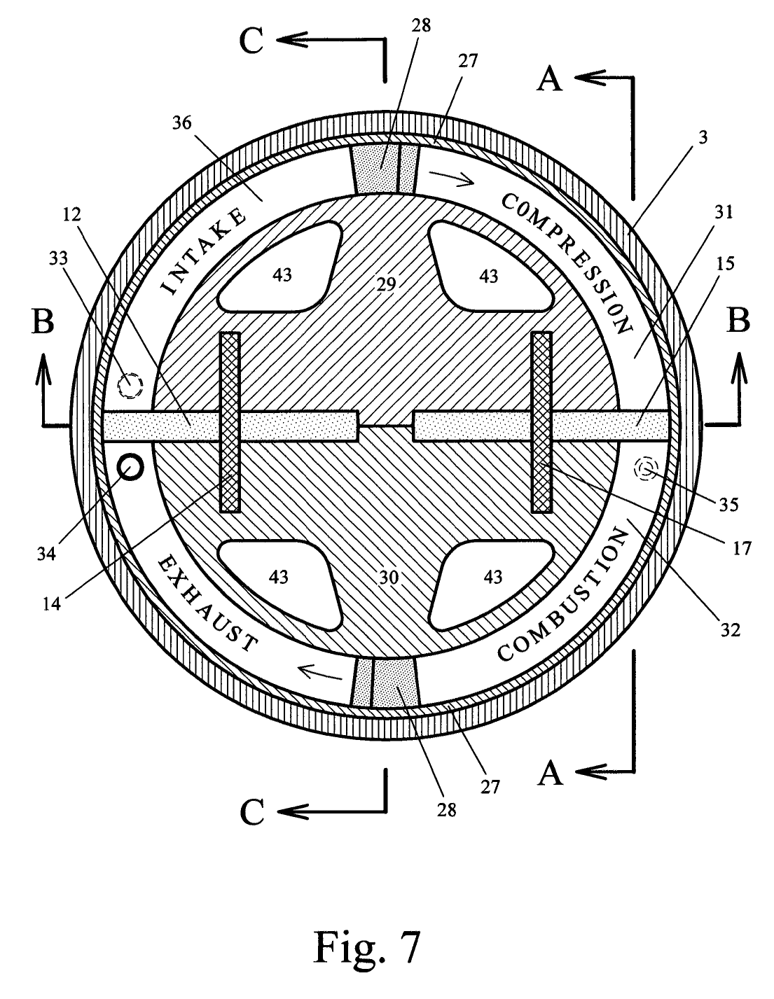

The front engine casing 29 and the rear engine casing 30, when assembled, form a single unit with a toroidal cylinder cavity 36 around its perimeter FIG. 5. The intake disk valve 12 and the compression disk valve 15 provide a means for controlling the pressures within the cylinder cavity 36 by allowing the orbital pistons to move from the compression chamber 31 to the combustion chamber 32 FIG. 7 while maintaining the pressures within these two chambers. The intake disk valve 12 and compression disk valve 15 are driven by a gear train comprised of gears 16, 18, 26, 20, 22 and 13 FIG. 6. The gear train receives its rotation from the central driveshaft 24 that is connected to the vertical driveshaft 10 by miter gears 11 and 25.

Refer to FIG. 7 for a graphical aid for the description of the four (4) cycles of the present invention.

The intake cycle begins when orbital piston 28 passes through the intake disk valve piston slot 38 and the intake disk valve 12 rotates to seal the compression chamber 31. The orbital piston 28 rotates in the direction indicated in FIG. 7 forming a vacuum at the intake port 33, filling the compression chamber 31 with a fuel-air mixture. The orbital piston 28 then passes through the compression disk valve 15 completing the intake cycle.

The next orbital piston 28 in rotation, which passes through the intake disk valve 12 and moves in the direction indicated in FIG. 7, compresses the fuel-air mixture into the pre-combustion chamber 39 within the compression disk valve 15 before passing through the compression disk valve piston slot 44 and completing the compression cycle.

The pre-combustion chamber 39 now containing the fuel-air mixture is sealed momentarily on both sides by engine casings 29 and 30. The compression disk valve 28 continues to rotate, exposing the pre-combustion chamber discharge port 41 to the combustion chamber 32 and discharging the fuel-air mixture at the rear of orbital piston 28. At this point, the fuel-air mixture is ignited from the ignition port 35, propelling the orbital piston 28 through the intake disk valve and completing the combustion cycle.

The next orbital piston 28 that is in rotation after passing through the compression disk valve 15 forces the spent fuel mixture out the exhaust port 34, completing the exhaust cycle.

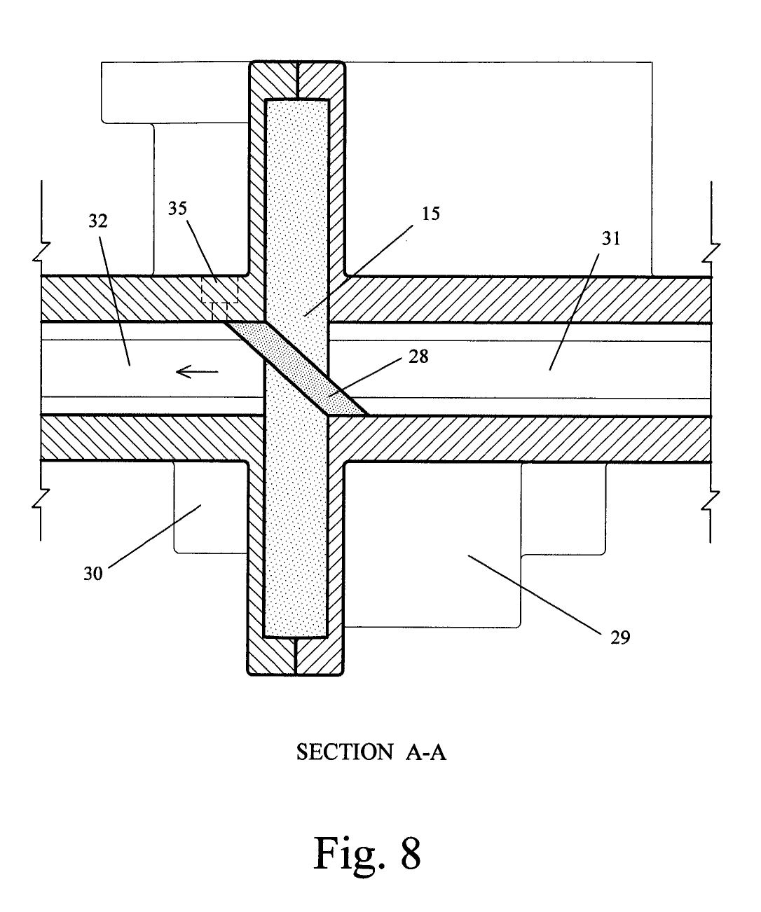

The four (4) cycles of the engine—intake, compression, combustion and exhaust—take place within 180 degrees of engine rotation. Orbital piston 28 passes through the intake disk valve 12 at the same time that the opposite orbital piston passes through the compression disk valve 15 FIG. 8. Both the intake disk valve 12 and the compression disk valve 15 open and close at the time that the compression chamber 31 and the combustion chamber 32 go through their respective cycles. At any one time, each of the four cycles of the engine is simultaneously occurring at the front and rear sides of the two (2) orbital pistons 28 as they rotate within the cylinder cavity 36.

All ignition control, fuel mixture control, and starting systems can be accommodated by existing marketed components.

### DETAILED DESCRIPTION OF DRAWINGS

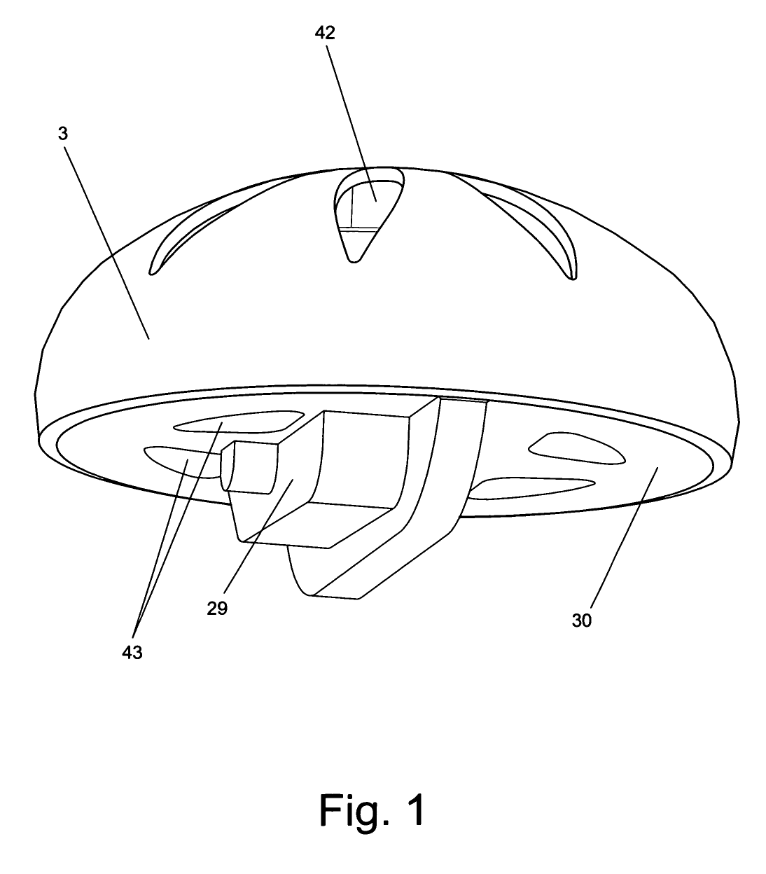

FIG. 1, a front perspective view of the assembled rotary engine, shows the rotary head 3 with rotary head air flow openings 42 for cooling of the engine. The rotary head 3 rotates while the front engine casing 29 and the rear engine casing 30 remain stationary. Engine casing air flow openings 43 allow air to pass through the engine casing for cooling of the engine.

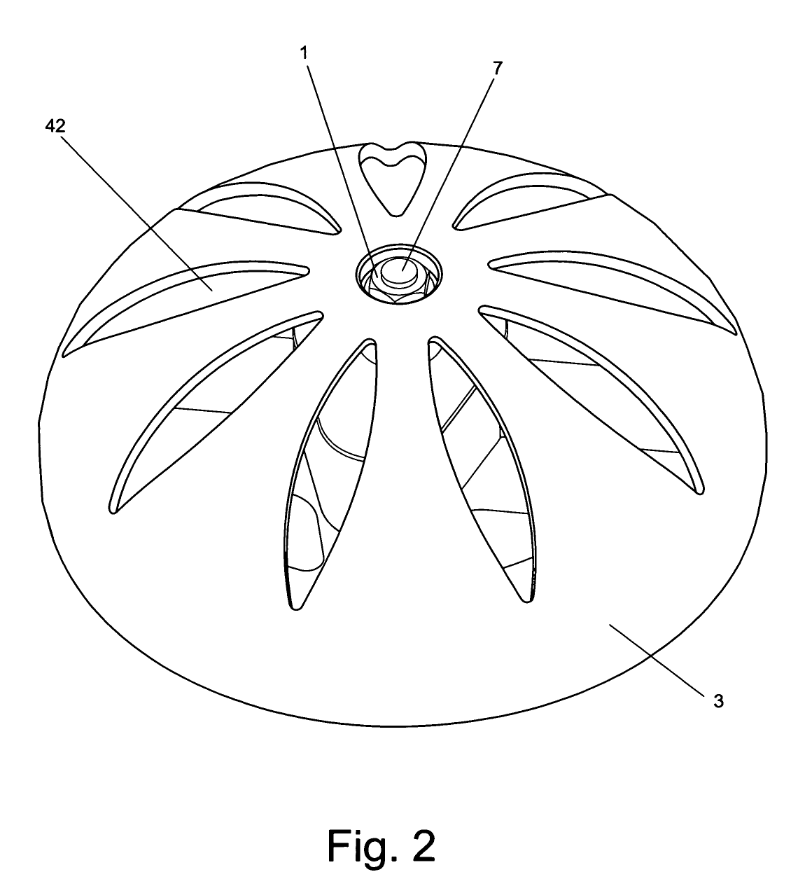

FIG. 2, a top perspective view of the assembled rotary engine, shows the rotary head 3 with nine (9) rotary head air flow openings 42 for cooling of the engine. The spindle 7 supports the bearings for the rotation of the rotary head 3 that is held in place by the retaining nut 1 and the retaining washer 2.

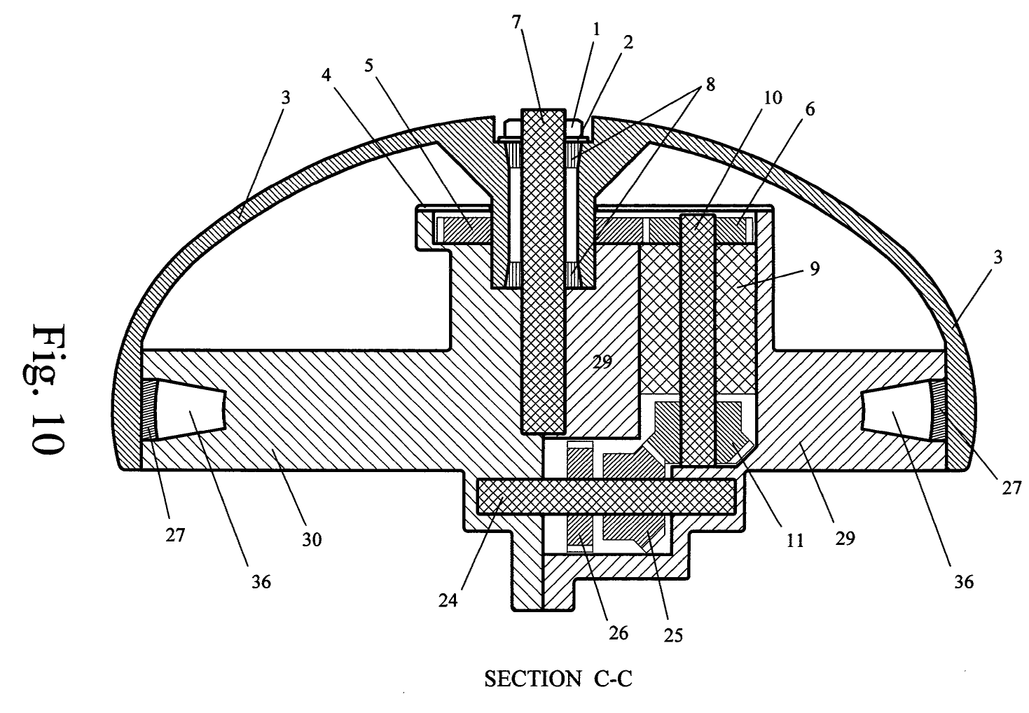

FIG. 3, an exploded view of the rotary engine, shows the retaining nut 1 and the retaining washer 2 as being removed to allow the rotary head 3 to be lifted. The drive gear cover 4 protects the output gear 5 and the driveshaft gear 6 and prevents leakage of gear lubricant. The output gear 5 is fixed to the rotary head 3 and forces the rotation of the driveshaft gear 6. The rotary head 3 rides on the spindle bearings 8 seated on the spindle 7. Spindle 7 is fixed inside the spindle cavity 37 at a central point between the front engine casing 29 and the rear engine casing 30. The driveshaft bushing 9 provides a lubricated surface within for the driveshaft 10. The driveshaft gear 6 is fixed to the upper end of driveshaft 10 and the driveshaft miter gear 11 is fixed to the lower end of driveshaft 10. The driveshaft bushing 9 as well as the drive shaft 10, driveshaft gear 6 and the driveshaft miter gear 11 rest in the driveshaft bushing cavity 45 in the front engine casing 29. The intake disk valve 12 is fixed to the intake disk valve drive gear 13 and the intake disk valve shaft 14. The intake disk valve shaft 14 rests on the right side of the front engine casing 29 and rear engine casing 30. The compression disk valve 15, shown with the pre-combustion chamber inlet port 40 FIG. 10, is fixed to the compression disk valve drive gear 16 and the compression disk valve shaft 17. The compression disk valve shaft 17 rests on the left side of the front engine casing 29 and rear engine casing 30. The compression disk valve idler gear 18 is fixed to the compression disk valve idler gear shaft 19, which is seated in the front engine casing 29 and rests adjacent to the compression disk valve drive gear 16. The intake disk valve idler gear “A” 20 and the intake disk valve idler gear “A” shaft 21 are hidden behind the driveshaft miter gear 11 in this figure. The intake disk valve idler gear “B” 22 is fixed to the intake disk valve idler gear “B” shaft 23, which is seated in the front engine casing 29 and rests adjacent to the intake disk drive gear 13. The central driveshaft 24 is fixed to the central driveshaft miter gear 25 and the central driveshaft gear 26 and is located along the center line of the engine with the forward end resting in the front engine casing 29 and the rear extending through the rear engine casing 30. The orbital piston 28 is shown attached to the compression ring 27. The cylinder cavity 36 is shown behind the compression disk valve 15 and is covered by the rotary head 3.

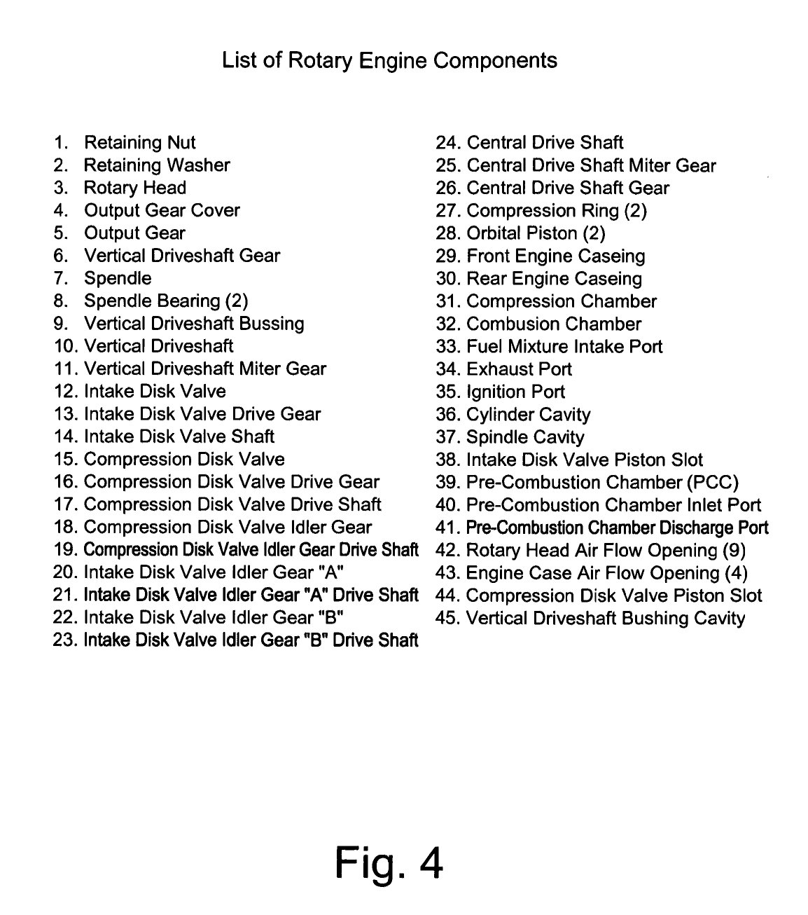

FIG. 4 is a list of rotary engine components 1 through 45.

FIG. 5 is a top perspective view of the rotary engine with the rotary head 3, compression ring 27 and the orbital pistons 28 removed. The retaining nut 1 and retaining washer 2 that secure the rotary head 3 remain in place. The drive gear cover 4 is in place at the top of the front engine casing 29 and the rear engine casing 30. The spindle 7 with the spindle bearings 8 are at a center point between the front engine casing 29 and the rear engine casing 30. The fuel mixture intake port 33 is located in the upper section of the front engine casing 29 above the cylinder cavity 36 and adjacent to the intake disk valve 12. The exhaust port 34 is located in the lower section of the rear engine casing 30, below the cylinder cavity 36 and adjacent to the intake disk valve 12. The ignition port 35 is located in the upper section of the engine casing 30, above the cylinder cavity 36 and adjacent to the compression disc valve 15. The cylinder cavity 36 is located on the outside perimeter of the front engine casing 29 and the rear engine casing 30. The engine casing air flow openings 43 are located adjacent to the cylinder cavity 36. There are also two in the front engine casing 29 and two in the rear engine casing 30.

FIG. 6 is a front perspective view with the removal of the front engine casing 29 and the compression rings 27. The retaining nut 1 and the retaining washer 2 are shown in their assembled position at the top of the rotary head 3. The output gear 5 is fixed to the rotary head 3, forcing the rotation of the driveshaft gear 6. The spindle 7 is fixed in the spindle cavity 37 at a central point between the front engine casing 29 and the rear engine casing 30. Spindle bearings 8 are set on the spindle 7 to allow free rotation of the rotary head 3. Driveshaft 10 has the driveshaft gear 6 fixed at the upper end and the driveshaft miter gear 11 fixed at the lower end. The driveshaft bushing 9 along with the drive shaft 10, driveshaft gear 6 and the driveshaft miter gear 11 rest within the driveshaft bushing cavity 45, located in the front engine casing 29. The intake disk valve 12 with the intake disk valve piston slot 38 is fixed to the intake disk valve drive gear 13 and the intake disk valve shaft 14. The intake disk valve shaft 14 rests on the right sides of the front engine casing 29 and rear engine casing 30. The compression disk valve 15, shown with the compression disk valve piston slot 44 and the pre-combustion chamber inlet port 40 FIG. 10, is fixed to the compression disk valve drive gear 16 and the compression disk valve shaft 17. The compression disk valve shaft 17 rests on the left sides of the front engine casing 29 and rear engine casing 30. The compress disk valve idler gear 18 is fixed to the compression disk valve idler gear shaft 19, which is seated in the front engine casing 29 and rests adjacent to the compression disk valve drive gear 16. The intake disk valve idler gear “A” 20 is fixed to the intake disk valve idler gear “A” shaft 21, which is seated in the front engine casing 29 and rests adjacent to the central driveshaft gear 26. The intake disk valve idler gear “B” 22 is fixed to the intake disk valve idler gear “B” shaft 23, which is seated in the front engine casing 29 and rests adjacent to the intake disk drive gear 13. The central driveshaft 24 is fixed to the central driveshaft miter gear 25 and the central driveshaft gear 26 and is located along the center line of the engine, with the forward end resting in the front engine casing 29 and the other end resting in the rear engine casing 30. The orbital pistons 28 are shown attached to each of the compression rings 27, which are fixed to the inside of the rotary head 3. The cylinder cavity 36 is shown on the outside perimeter of the front engine casing 29 and rear engine casing 30.

FIG. 7 is a plan view showing the four cycles of the rotary engine. The rotary head 3 is fixed to the two compression rings 27 that seal the cylinder cavity 36. The intake disk valve 12 is fixed to the intake disk valve shaft 14. The compression disk valve 15 is fixed to the compression disk valve shaft 17. The orbital pistons 28 fixed to the compression rings 27 are shown at the midpoint of their cycles—intake, compression, combustion and exhaust—within the front engine casing 29 and rear engine casing 30. The fuel mixture intake port 33 is located in the upper section of the front engine casing 29, above the cylinder cavity 36 and adjacent to the intake disk valve 12. The exhaust port 34 is located in the lower section of the rear engine casing 30, below the cylinder cavity 36 and adjacent to the intake disk valve 12. The ignition port 35 is located in the upper section of the rear engine casing 30, above the cylinder cavity 36 and adjacent to the compression disk valve 15. The cylinder cavity 36 is located on the outside perimeter of the front engine casing 29 and the rear engine casing 30. The engine casing air flow openings 43 are located adjacent to the cylinder cavity 36 with two openings in the front engine casing 29 and two in the rear engine casing 30. Lines A-A, B-B and C-C are detail sections shown in FIGS. 6, 7 and 8, respectively.

FIG. 8 is a section along line A-A in FIG. 7. The orbital piston 28 is shown passing through the compression disk valve piston slot 44 in the compression disk valve 15. The orbital piston 28, moving as is indicated by the direction arrow, is leaving the compression chamber 31 and entering the combustion chamber 32. The ignition port 35 is shown above the combustion chamber 32, adjacent to the compression disk valve 15. The front engine casing 29 and rear engine casing 30 are shown in the background.

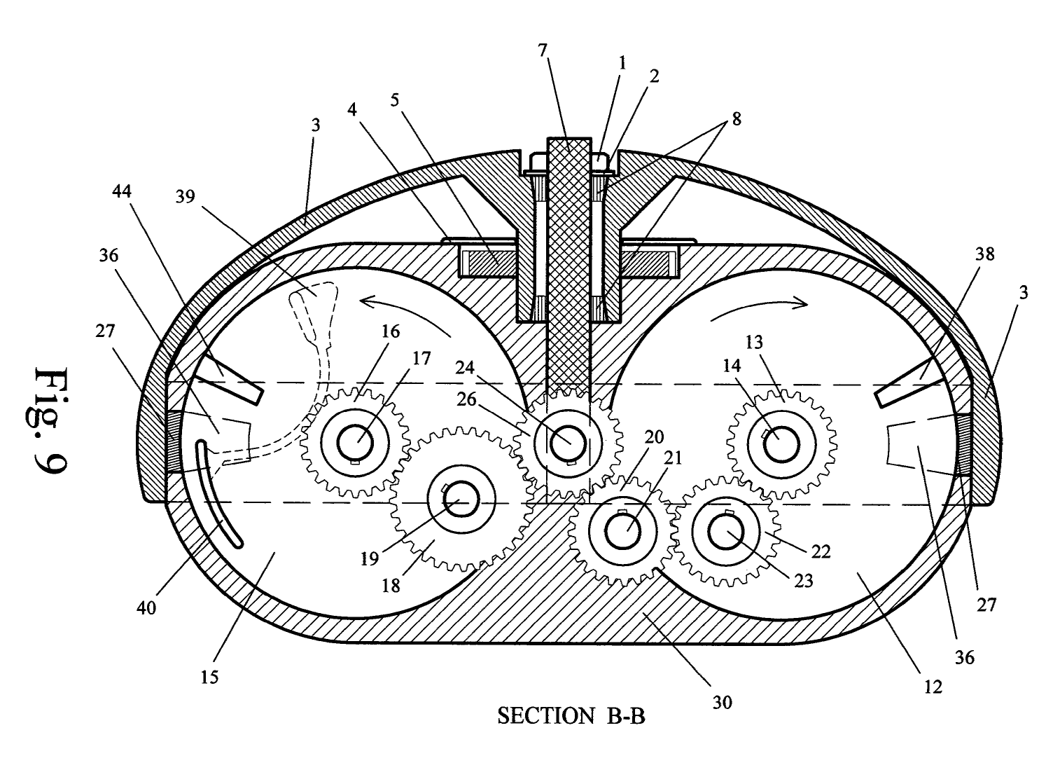

FIG. 9 is a section along line B-B in FIG. 7. The retaining nut 1 and the retaining washer 2 are shown in their assembled position at the top of the rotary head 3. The output gear 5 is fixed to the rotary head 3. The drive gear cover 4 is in place at the tops of the front engine casing 29 and the rear engine casing 30. The spindle 7 is fixed at a central point between the front engine casing 29 and the rear engine casing 30. Spindle bearings 8 are set on the spindle 7 to allow free rotation of the rotary head 3. The intake disk valve 12 with the intake disk valve piston slot 38 is fixed to the intake disk valve drive gear 13 and the intake disk valve shaft 14. The compression disk valve 15 with the compression disk valve piston slot 44 and the pre-combustion chamber inlet port 40 is fixed to the compression disk valve drive gear 16 and the compression disk valve shaft 17. The compression disk valve shaft 17 rests on the left sides of the front engine casing 29 and rear engine casing 30. The compression disk valve idler gear 18 is fixed to the compression disk valve idler gear shaft 19, which is seated in the front engine casing 29 and rests adjacent to the compression disk valve drive gear 16. The intake disk valve idler gear “A” 20 is fixed to the intake disk valve idler gear “A” shaft 21, which is seated in the front engine casing 29 and rests adjacent to the central driveshaft gear 26. The intake disk valve idler gear “B” 22 is fixed to the intake disk valve idler gear “B” shaft 23, which is seated in the front engine casing 29 and rests adjacent to the intake disk drive gear 13. The central driveshaft 24 is fixed to the central driveshaft gear 26 and is located along the centerline of the engine with the forward end resting in the front engine casing 29 and the rear portion resting in the rear engine casing 30. The cylinder cavity 36 is shown behind the intake disk valve 12 and the compression disk valve 15 and it is sealed around its perimeter with the compression rings 27 that are fixed to the rotary head 3.

FIG. 10 is a section along line C-C in FIG. 7. The retaining nut 1 and the retaining washer 2 are shown in their assembled position at the top of the rotary head 3. The output gear 5 is fixed to the rotary head 3 forcing the rotation of the driveshaft gear 6. The spindle 7 is fixed at a central point between the front engine casing 29 and the rear engine casing 30. Spindle bearings 8 are set on the spindle 7 to allow free rotation of the rotary head 3. The driveshaft bushing 9 provides a lubricated surface within for driveshaft 10. Driveshaft 10 has the driveshaft gear 6 fixed at the upper end and the driveshaft miter gear 11 fixed at the lower end that forces rotation of the central driveshaft miter gear 25. The central driveshaft 24 is fixed to the central driveshaft miter gear 25 and the central driveshaft gear 26 and is located along the centerline of the engine with the forward end resting in the front engine casing 29 with the rear resting in the rear engine casing 30. The compression rings 27 that are fixed to the rotary head seal the perimeter of the cylinder cavity 36.

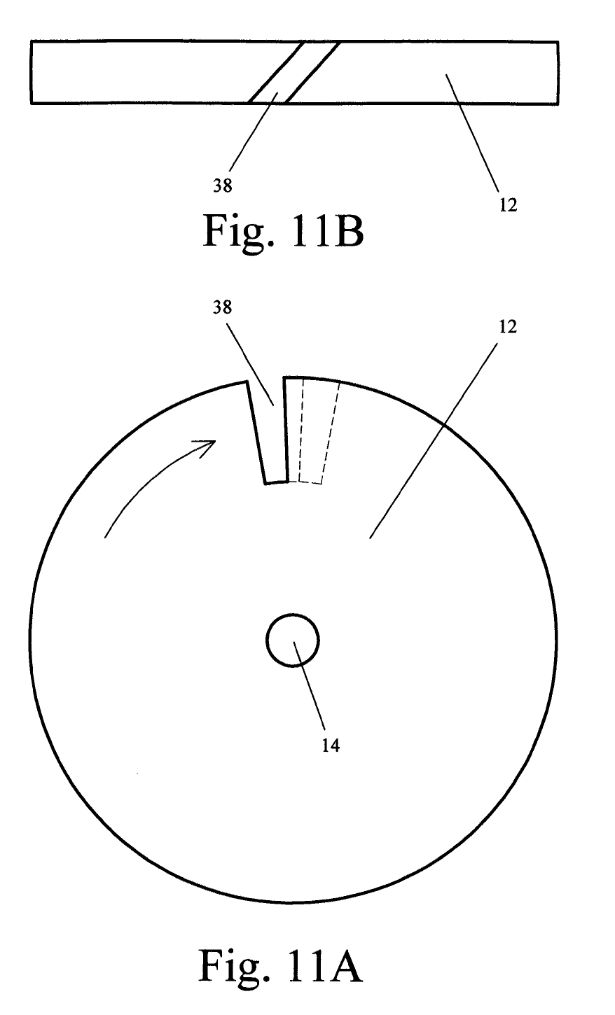

FIG. 11A is a detail of the intake disk valve 12 with the intake disk valve piston slot 38. The arrow shows the direction of rotation.

FIG. 11B shows the transverse view of the intake disk valve piston slot 38.

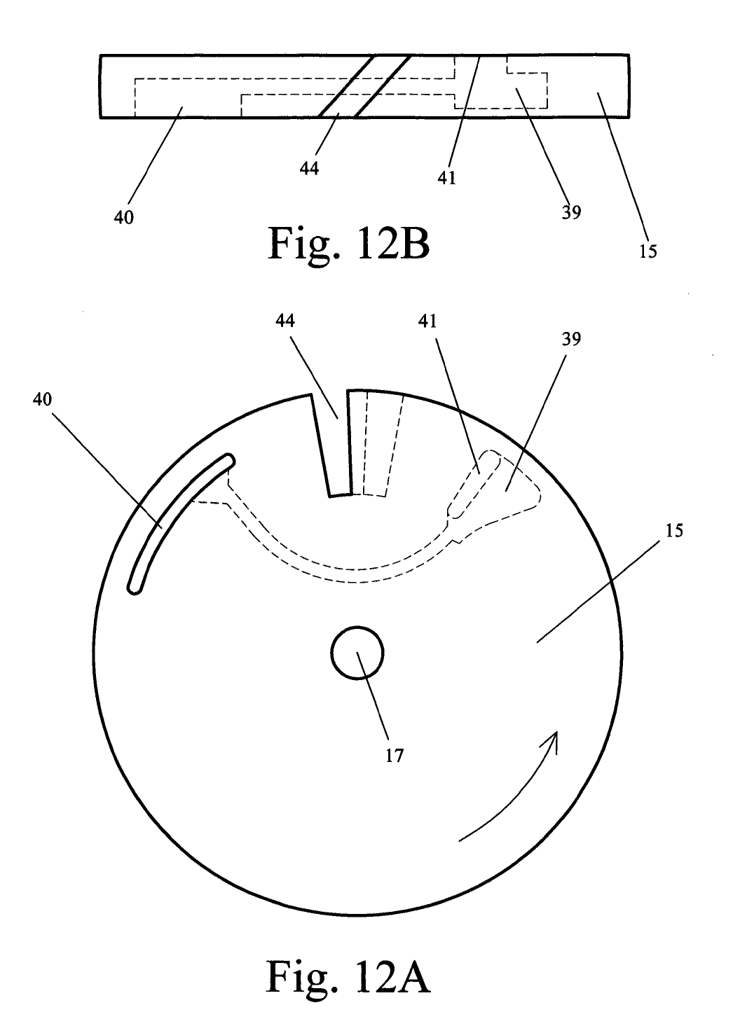

FIG. 12A is a detail of the compression disk valve 15 with the compression disk valve piston slot 44 and the pre-combustion chamber 39. An arrow shows the direction of rotation. The pre-combustion chamber consists of the pre-combustion chamber inlet port 40, located on the compression side, the pre-combustion cavity 39, located inside the compression disk valve 15, and the pre-combustion chamber discharge port 41, which is on the combustion side.

FIG. 12B shows a transverse view of the compression disk valve piston slot 44 and the pre-combustion chamber 39.

What is claimed:

1. An internal combustion rotary engine comprised of an engine core that has a toroidal chamber that is divided by transverse disk valves and contains a port for placement of a fuel-air mixture device and a port for placement of an exhaust system.

2. An internal combustion rotary engine of claim 1 that has a toroidal chamber that is divided by transverse disk valves that form a compression chamber in the front half and a combustion chamber at the rear half.

3. An internal combustion rotary engine of claim 1, which is also comprised of a compression and combustion chamber cover that contains a central opening for placement of a bearing shaft and orbital pistons fixed to compression rings that are mounted to the inside perimeter.

4. An internal combustion rotary engine of claim 1, further comprised of an intake disk valve containing an orbital piston slot and a central opening for placement of a bearing shaft.

5. An internal combustion rotary engine of claim 1, further comprised of a compression disk valve containing an orbital piston slot, a central opening for placement of a bearing shaft and a pre-combustion chamber.

6. An internal combustion rotary engine of claim 1, further comprised of an intake disk valve drive gear and shaft, a compression disk valve drive gear and shaft and a central driveshaft connected to a series of gears to impose rotation upon the internal components within the internal combustion rotary engine.

7. An internal combustion rotary engine of claim 1, comprised of an engine core made from alternative engine building materials including ceramics.

8. An internal combustion rotary engine of claim 1 that has alternate compression ratios to accommodate the combustion of a variety of fuels including diesel.

9. An internal combustion rotary engine of claim 1 that has a plurality of toroidal chambers in tandem to accommodate a variation of horse power requirements.

10. An internal combustion rotary engine of claim 9 that has a plurality of compression and combustion chamber covers.

11. A rotary engine as configured in claim 1 with modified disk valves that use an external source of expanding gases, not excluding steam, to provide engine rotation.

12. A rotary engine of claim 11 and claim 7 rotated by an external force to create a pump for a variety of liquids, not excluding hydrogen and other liquid gases.

13. A rotary engine comprised of an engine core that has a toroidal chamber that contains an intake port and an exhaust port, is divided by transverse disk valves and uses an external source of expanding gases, not excluding steam, to provide engine rotation.

14. A rotary engine comprised of an engine core that has a toroidal chamber that contains an intake port and an exhaust port and is divided by transverse disk valves and forms vacuum chambers when rotated by an external force to create a pump for a variety of liquids, not excluding hydrogen and other liquid gases.
